(19) United States
(12) Patent Application Publication
(10) Pub. No.: US 2007/0269055 A1
(43) Pub. Date: Nov. 22, 2007

(54) Feedback System for a Multiple Element Loudspeaker

(76) Inventor: Louis W. Erath, Abbeville, LA (US)

Correspondence Address: TIM COOK, P.O. BOX 10107, LIBERTY, TX, 77575, US

(21) Appl. No.: 11/383,883

(22) Filed: May 17, 2006

(51) Int. Cl. H04R 3/00; H04R 29/00

(52) U.S. Cl. 381/96; 381/59

(57) ABSTRACT

A control circuit enhances the frequency response of a loudspeaker. Separate control circuits are provided to control the frequency response of various ranges of the frequencies in the audible spectrum.

### FIELD OF THE INVENTION

This invention relates generally to sound reproduction systems, and more particularly to an improved feedback system which compensates for the nonlinear characteristics of a signal-to-sound transducer, such as a loudspeaker.

### BACKGROUND OF THE INVENTION

The following description is taken in large part from my earlier patent, U.S. Pat. No. 5,086,473 (the '473 patent) issued Feb. 4, 1992. In the field of sound reproduction, it is well known that the sound level produced by conventional loudspeakers diminishes near the limits of human hearing. For instance, at low frequencies, the mechanical and electrical characteristics of a loudspeaker tend to reduce the sound level output by the loudspeaker. This is primarily caused by the current limiting effects of the series resistance inherent in the speaker's drive coil at low frequencies.

There have been many attempts to compensate for these undesirable characteristics so that constant sound output from a loudspeaker can be achieved over the entire range of human hearing. These attempts have been made because the response of the human auditory system is not constant and varies with the frequency and intensity of sound waves. These inefficiencies of the human auditory system and the need for an appropriate compensation system for a loudspeaker are discussed in greater detail in my earlier U.S. Pat. No. 3,449,518 (the '518 patent) issued Jun. 10, 1969.

One method for compensating the low frequency inefficiencies of a loudspeaker is described in the '518 patent. The patent discloses a degenerative feedback network which attempts to maintain constant level of sound output from a loudspeaker. The loudspeaker is driven by a broad-band audio amplifier, and the circuit elements of the feedback network are tuned to match the low frequency response of the loudspeaker. The feedback network receives a current signal from the voice coil of the loudspeaker and delivers a degenerative feedback signal to an input of the broad-band audio amplifier. Since the degenerative feedback signal is “tuned” to cancel the undesirable response of the voice coil, the low frequency response of the loudspeaker is improved.

One embodiment of the feedback network of the '518 patent includes an inductor and a capacitor which are selected to be equivalent to the fundamental resonance of the speaker cone. The network further includes a resistor which is selected to represent the lumped mechanical resistance in the loudspeaker and an inductor that is selected to be equivalent to the leakage inductance of the voice coil. In other words, the frequency compensation network is selected to be equivalent to the impedance of the loudspeaker throughout the frequency range of the loudspeaker.

In theory, the frequency compensation network previously described should function quite well and produce a constant sound output level from the loudspeaker over its entire frequency range. In practice, however, this constant output level could not be achieved. This is primarily due to the non-ideal characteristics of the circuit elements of the frequency compensation network. For instance, inductors have some finite resistive component which interferes with the theoretical ideal characteristics of the feedback network. Therefore, the frequency compensating feedback network disclosed in the previously mentioned patent, while being an improvement in the art, does not fully correct the problem.

Another attempt to correct the low frequency inefficiencies of a loudspeaker is disclosed in U.S. Pat. No. 4,335,274 issued Jun. 15, 1982 to Ayers. To overcome basic defects in the low frequency response of a loudspeaker, two degenerative feedback circuits are provided which attempt to alleviate an impedance peak and an impedance valley in the low frequency range of the loudspeaker. A first feedback circuit applies degenerative feedback, proportional to the current flowing through the drive coil, to an audio amplifier; and a second feedback circuit applies degenerative feedback, proportional to voltage induced in feedback coil which is disposed about the voice coil of the loudspeaker, to the audio amplifier. However, one problem with this type of compensation system is that the speaker must be modified to accept the feedback coil. Another problem exists because reactive elements are used in the feedback circuits, and these reactive elements include non-ideal characteristics as mentioned previously.

Another method of compensating for the low frequency response characteristics of a loudspeaker utilizes a transducer to sense the sound pressure level output by the loudspeaker. In response to the sound pressure level, a feedback signal, proportional to the sound output level of the loudspeaker, is applied to an associated audio amplifier. While this does raise the low frequency response of a loudspeaker, it does not necessarily provide a constant sound output level. Moreover, the transducers themselves have limited frequency response characteristics, and, therefore, cannot fully overcome the poor low frequency response characteristics of the associated loudspeaker.

While the frequency response adjustment system of my '473 patent has proved most effect, it is in some respects more complex than is necessary. Thus, there remains a need to simplify the frequency compensation scheme of my '473 patent while maintaining the excellent performance that it provides. The present invention is directed to solving this need in the art.

### SUMMARY OF THE INVENTION

In accordance with one aspect of the present invention, there is provided an apparatus for enhancing the low frequency response of a loudspeaker which includes an automatic adjustment circuit in the feedback portion of the audio amplifier circuit. The loudspeaker preferably includes an acoustic wave producing member, and a drive coil having first and second terminals. The drive coil is adapted to produce movement of the acoustical wave producing member.

The loudspeaker is powered by the audio amplifier which delivers an amplified audio signal to the loudspeaker. The apparatus includes a feedback circuit which is operably connected to the audio amplifier and which automatically adjusts the feedback level to account for rolloff in low frequencies at the loudspeaker.

Also included is a transformer having a primary winding and a secondary winding. The primary winding is adapted to connect to the second terminal of the drive coil, and the secondary winding is connected to the feedback circuit. The feedback circuit delivers a feedback signal which alters the audio input signal in response to a voltage induced on the secondary winding by the primary winding.

The feedback circuit preferably includes an operational amplifier (op amp) which is adapted to receive an audio input signal and to deliver an amplified audio input signal to the input of the audio amplifier. A frequency compensating circuit has an input which is connected to the secondary winding of the transformer and an output which is connected to the input of the operational amplifier. The frequency compensating circuit delivers a feedback signal in response to a voltage induced on the secondary winding by the primary winding, and the feedback signal has a phase and magnitude which alters the audio input signal to cause the audio amplifier to output a driving signal that is correlative to the amplified audio input signal and that compensates for impedance variations of the drive coil.

The feedback circuit also preferably includes a resonance matching circuit which is tuned to electrically match the impedance of the loudspeaker within a predetermined frequency range. The resonance matching circuit is adapted to receive the driving signal and to deliver an output signal which alters the feedback signal in response to the frequency of the driving signal.

In accordance with another aspect of the present invention, there is provided a method for enhancing the low frequency response of a loudspeaker. The loudspeaker preferably includes an acoustic wave producing member, and a drive coil which is adapted to produce movement of the acoustical wave producing member. The method includes the steps of delivering a current signal to the drive coil; electrically matching the impedance of the loudspeaker in response to the current signal; sensing current flowing through the drive coil, while being electrically isolated from the impedance of the drive coil; and altering the magnitude of the current signal in response to the frequency of the sensed current.

### BRIEF DESCRIPTION OF THE DRAWINGS

The advantages of the invention will become apparent upon reading the following detailed description and upon reference to the drawings in which:

FIG. 1 is a schematic diagram which represents a known frequency compensating feedback system for a loudspeaker in accordance with my '473 patent.

FIG. 2 is a schematic diagram of a known frequency compensating feedback system and a level compensation network.

FIG. 3 is a schematic diagram of a presently preferred embodiment of a frequency compensating feedback system in accordance with the present invention.

While the invention is susceptible to various modifications and alternative forms, specific embodiments thereof have been shown by way of example in the drawings and will be described in detail herein. It should be understood, however, that it is not intended to limit the invention to the particular forms disclosed, but on the contrary, the invention is to cover all modifications, equivalents, and alternatives falling within the spirit and scope of the invention as defined by the appended claims.

### DETAILED DESCRIPTION OF A PREFERRED EMBODIMENT

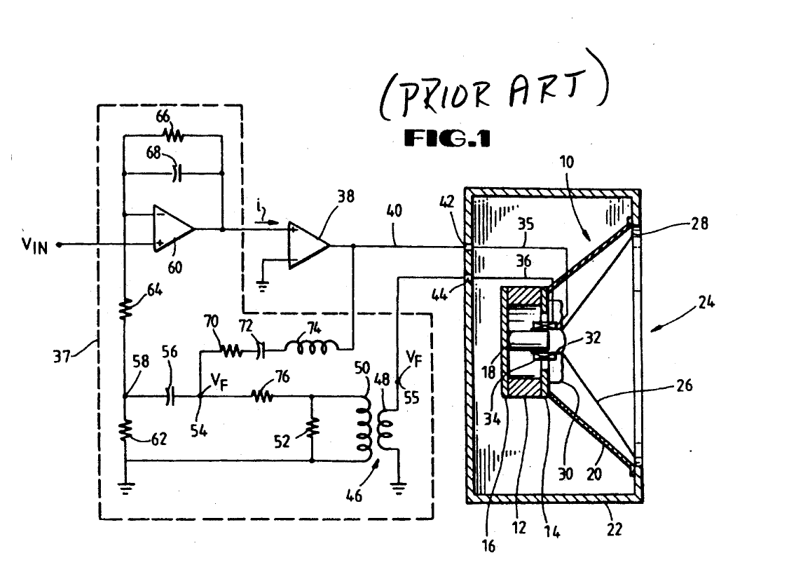

FIG. 1 depicts a loudspeaker and feed back system of my U.S. Pat. No. 5,086,473 of which the present invention comprises an improvement. The loudspeaker of my prior system is generally designated by a reference numeral 10 and is preferably a sub-woofer which is designed to emit acoustical waves having frequencies below about 200 hertz. For instance, if the frequency response of a loudspeaker system rolls off below 100 hertz, then a sub-woofer which is designed to enhance frequencies below 100 hertz could be used with the loudspeaker system to extend the frequency response to the lower limits of human hearing (about 20 hertz).

The loudspeaker 10 includes an annular magnet 12 which is mounted in a magnetic structure between a front plate 14 and a back plate 16. The annular magnet 12 encompasses a pole piece 18 to produce a magnetic flux which is used to drive the loudspeaker 10. A conically-shaped basket 20 is connected to the front plate 14 and extends outwardly therefrom in order to accurately position a cone 26 adjacent the magnetic structure. The cone 26 is typically made of a lightweight material, such as paper, plastic, metal, or composite material, to enhance the response of the loudspeaker 10. The cone 26 is suspended by a surround 28 which connects the cone 26 to the outwardly extending edge of the basket 20, and by a spider 30 which is attached to the outer periphery of a cylindrical form 32 such that the cylindrical form 32 is disposed concentrically about the pole piece 18. A drive coil 34 is disposed about the cylindrical form 32 so that changes in current through the drive coil 34 alter the magnetic field between the magnet 12 and the pole piece 18 and cause the cylindrical form 32 to slide axially along the pole piece 18.

Preferably, the axial length of the drive coil 34 should be about three times the thickness of the front plate 14 so that the cone 26 is capable of large excursions while maintaining a substantially constant number of turns of the drive coil 34 in the intense portion of the magnetic field. This helps avoid distortion at the low frequencies produced by the sub-woofer. Moreover, the cone 26 should be fairly rigid and it should move as a piston in a selected lower frequency range, e.g., from about 20 hertz to about 200 hertz. The light weight of the cone 26 makes the cone more efficient at converting alternating current into sound pressure. Furthermore, the suspension, i.e., the surround 28 and the spider 30, should be compliant to allow an excursion of at least ±0.25 inches. With this type of construction, the mass of the cone 26 and the stiffness of the suspension should resonate at about 30 hertz in free air.

Preferably, the loudspeaker 10 is mounted in a cabinet 22 in order to raise the resonance of the cone 26 to about 70 hertz. The cabinet 22 is totally enclosed in that it has no ports other than an opening 24 in which the loudspeaker 10 is mounted, and the cubic volume of the cabinet 22 is such that the stiffness of the air within the cabinet 22 adds support to the cone 26. Preferably, the cabinet 22 is small compared to the wavelength of the sound waves produced by the loudspeaker 10. Therefore, at frequencies below the peak resonance of the cone 26, the impedance of the loudspeaker 10 is substantially controlled by the stiffness of the air within the enclosure 22. At frequencies above the resonance of the cone 26, the impedance of the loudspeaker 10 is controlled by the mass of the suspended system, which includes the cone 26 and the voice coil 34.

Impedance peaks are caused primarily by the mechanical resonance of the speaker, and the drive coil 34 appears as a high impedance load. Conversely, impedance valleys are a result of electrical self-inductance of the drive coil 34 and the apparent capacitance of the moving mass due to the cone 26 and the drive coil assembly 34. At the impedance valleys, the drive coil 34 appears nearly resistive, and thus becomes a low impedance load. Since these peak and valley resonances are undesirable due to their adverse effect on the low frequency response of the loudspeaker 10, an external feedback circuit 37 is provided which alters the magnitude of the current delivered to the drive coil 34 to compensate for the inherent resonances of the loudspeaker 10.

A current signal is delivered to the drive coil 34 by a broad-band audio power amp 38, referred to herein as a power amp 38. The output of the power amp 38 is connected to a terminal 42 on the cabinet 22 by a conductor 40. A lead 35 of the drive coil 34 is also connected to the terminal 42 so that the drive coil 34 is serially connected to the output of the power amp 38. As will subsequently become apparent, the current signal is an audio input signal Vᵢₙ which has been amplified by the power amp 38 and which has been modified by the feedback circuit 37 that delivers a feedback signal to the input of the power amp 38.

The elements of the feedback circuit 37 are selected to offset the effects of the impedance variations previously described, depending on whether the speaker 10 is being used in free air or within the enclosure 22, respectively. The feedback circuit 37 is isolated from the drive coil 34 by a transformer 46. The primary coil 48 of the transformer 46 is connected to a lead 36 of the drive coil 34 via a terminal 44, and the other end of the primary coil 48 is connected to circuit ground. The secondary coil 50 of the transformer 46 is connected to the feedback circuit 37 so that the elements of the feedback circuit are isolated from the drive coil 34. The isolation of the transformer 46 allows the elements of the feedback circuit 37 to operate nearly ideally to cancel the undesirable effects of the loudspeaker 10.

Preferably, the primary coil 48 is comprised of 20 turns of an 18 gauge wire, while the secondary coil 50 is comprised of 200 turns of a 26 gauge wire, thus providing a transformer having a 100:1 impedance transformation. Therefore, the impedance of the secondary coil 50 is much greater than the impedance of the primary coil 48 so that the feedback circuit 37 is buffered from the drive coil 34. For instance, if the value of the secondary coil 50 is 10 millihenries, then the secondary coil 50 has an impedance of 6 ohms at 100 hertz and an impedance of 1.2 ohms at 20 hertz.

A portion of the feedback circuit 37 provides the proper phase and amplitude of the feedback signal in response to the current flowing through the drive coil 34 which is sensed by the transformer 46. The secondary coil 50 is shunted by a resistor 52 which is connected in a parallel arrangement with the secondary coil 50. If the resistor 52 is, for example, 10 ohms, the impedance of the secondary winding 50 is largely inductive below the resonance at 70 hertz and becomes resistive at frequencies above 100 hertz. Therefore, as the frequency of the current signal through the drive coil 34 falls below 70 hertz, the feedback signal V_{f} at a node 54 becomes progressively smaller in magnitude. Since the node 54 is operably connected to the input of the power amp 38, the signal delivered by the power amp 38 rises in magnitude.

It is desirable to provide an impedance matching network which is the precise electrical equivalent of the loudspeaker 10. To match the response of the loudspeaker 10, a resistor 70, capacitor 72, and an inductor 74 are connected in series between the node 54 and the output of the power amp 38 to form a resonance matching network within the feedback circuit 37. Current flowing through the resonance matching network induces a voltage across a resistor 76 which is connected between the node 54 and the secondary winding 50. Notice that the feedback signal V_{f} is the same at nodes 54 and 55 since the impedance of the drive coil 34 is being matched by the impedance matching network. Therefore, the feedback from the resonance matching network compliments the frequency compensating feedback from the transformer 46, and produces a feedback signal V_{f} that is relatively unaffected by the loading of the drive coil 34. For example, when the frequency of the audio input signal Vin is near the resonance peak of about 70 hertz, the feedback signal produced by the feedback circuit 37 increases so that the output of the power amp 38 decreases by an appropriate amount to exactly compensate for the resonant action of the speaker.

To further reduce the feedback signal as the frequency approaches 20 hertz, a capacitor 56 is inserted in the feedback circuit 37 between the node 54 and an input node 58. The input node 58 is connected to the inverting input of an operational amplifier 60 via a resistor 64. A resistor 62 connects the input node 58 to circuit ground, and the values of the capacitor 56 and the resistor 62 are selected to enhance roll-off of the feedback signal at low frequencies. A feedback resistor 66 is connected between the inverting input of the operational amplifier 60 and the output of the operational amplifier 60. Also connected in the feedback loop of the operational amplifier 60 is a capacitor 68. The capacitor 68 is present to roll-off or diminish the high frequency response of the operational amplifier 60.

With the feedback circuit 37 in place, the audio input signal Vᵢₙ is received at the non-inverting input of the operational amplifier 60. The audio input signal Vᵢₙ is affected by the feedback of the operational amplifier 60 and by the feedback signal V_{f} from the feedback circuit 37 because the feedback signal V_{f} alters the gain of the operational amplifier 60. Therefore, a compensated signal is output to the non-inverting input of the power amp 38. The output of the power amp 38 is delivered to the drive coil 34, and produces a current flow through the drive coil 34. The current through the drive coil 34 produces a magnetic field which cause axial motion of the cylindrical form 32 along the pole piece 18. The current through the drive coil 34 flows through the lead 36 to the connector terminal 44 and to circuit ground via the primary coil 48 of the transformer 46.

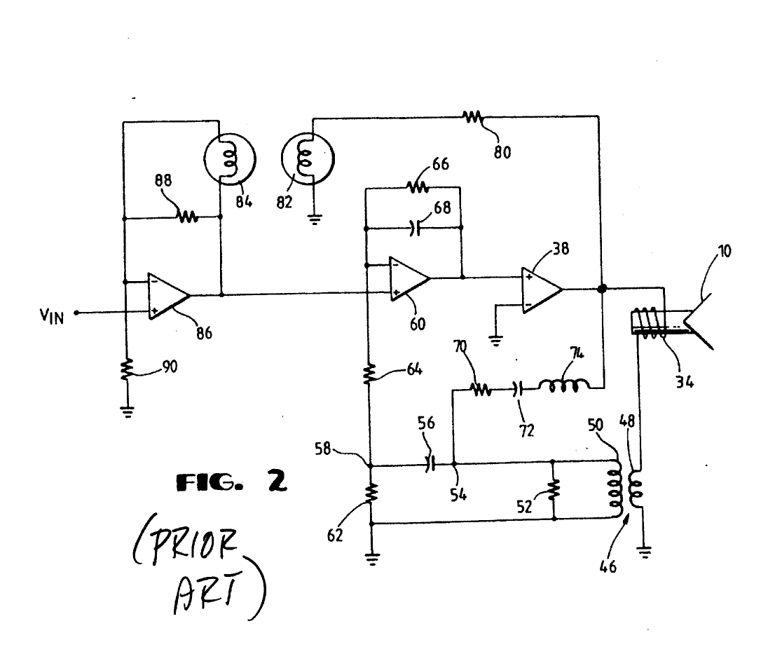

To compensate for the loudness level, i.e., the amplitude of the audio input signal Vᵢₙ, a known level compensation circuit may be added to the feedback circuit 37 previously described. As shown in FIG. 2 from my '473 patent, a resistor 80 and a light emitting element 82, such as a light emitting diode or an incandescent lamp, are connected between the output of the power amp 38 and circuit ground. As the amplitude of the signal at the output of the power amp 38 increases, the current flowing through the resistor 80 and through light emitting element 82 increases. Above a certain level, the current causes the light emitting element 82 to glow, and the radiation emitted from the light emitting element 82 impinges on a photo resistive transducer 84 which is operatively positioned to receive the radiation.

The photo resistive transducer 84 is connected in a feedback loop of an operational amplifier 86 along with feedback resistor 88. When the light emitting element 82 is not emitting radiation, the resistance of the photo resistive transducer 84 is very high compared to the resistance of the resistor 88. Therefore, the gain of the operational amplifier 86 is primarily determined by the feedback resistor 88 and a resistor 90 which is connected between the inverting input of the amplifier 86 and circuit ground. The audio input signal Vᵢₙ is delivered through the non-inverting input of the amplifier 86 and the amplifier 86 delivers an amplified audio signal to the non-inverting input of the operational amplifier 60. The feedback circuit 37 then modifies the amplified audio signal as previously described.

However, when the light emitting element 82 begins to glow, the radiation received by the photo resistive transducer 84 causes the resistance of the photo resistive transducer to decrease, so that the gain of the operational amplifier 86 is determined by the parallel value of the resistances 84 and 88 as well as by the resistance 90. Since the parallel combination of the resistances 84 and 88 produces a feedback resistance which is less than the value of the resistance 88 alone, the overall gain of the operational amplifier 86 decreases. When the amplitude of the signal at the output of the power amp 38 reaches a certain level, the light emitting element 82 glows at a substantially constant intensity. At this substantially constant intensity, the resistivity of the photo resistive transducer 84 is drastically reduced so that the effect of the photo resistive transducer 84 on the feedback of the amplifier 86 is dominant, and therefore allows the amplifier 86 to maintain a substantially constant gain. This substantially constant gain is relatively low compared to the gain of the amplifier 86 when the resistance of the photoresistive transducer 84 is high. Hence, the level compensation circuit smoothly reduces the level of the audio input signal Vin to avoid the undesirable effects of an intense signal.

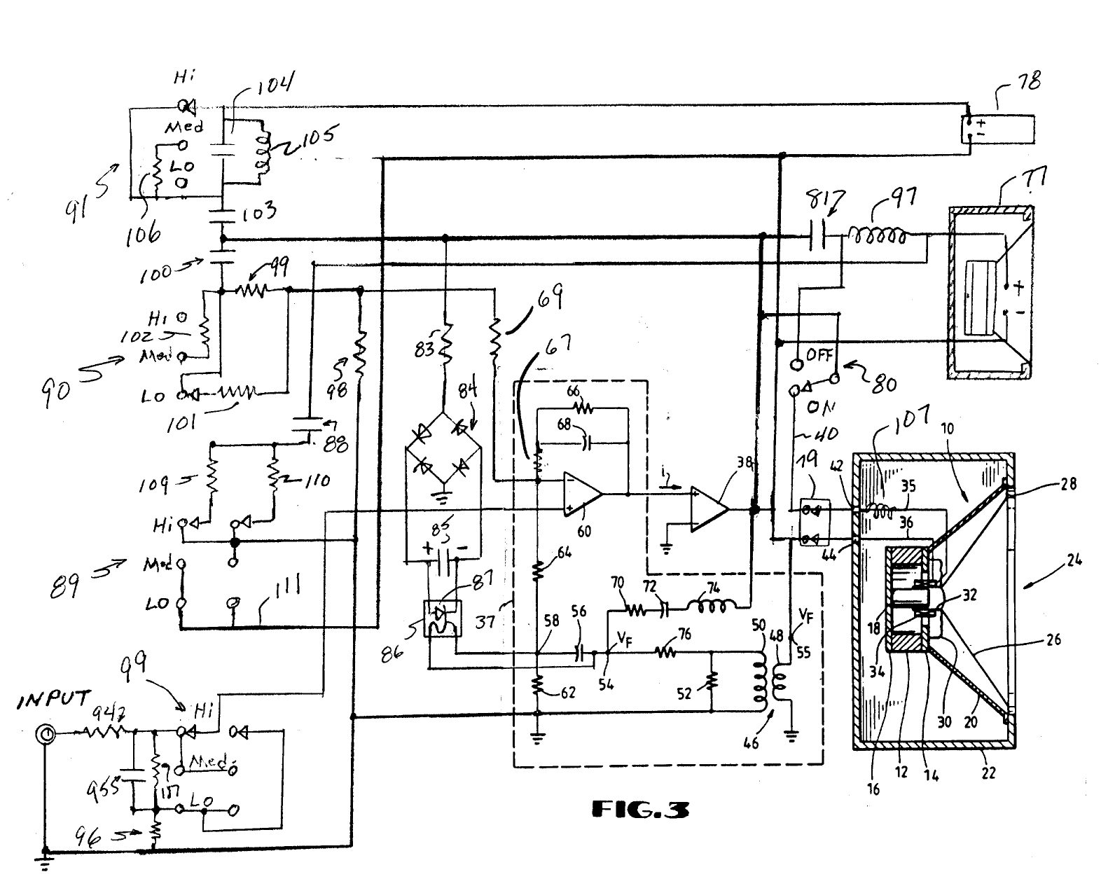

The loudness control of FIG. 2 may be improved by the control circuit of FIG. 3 in accordance with the present invention. The control circuit of FIG. 3 includes the feedback circuit 37 previously described, but also includes a feedback resistor 83, a bridge rectifier 84, a filter capacitor 85, and a Vatec cell 86. The Vatec cell 86 is a photodiode available from EG&G Vatec. The bridge rectifier 84 converts the audio output of the power amp 38 into a d.c. signal. This d.c. signal is filtered by the filter capacitor 85, and the voltage level of this signal is determined by the feedback resistor 83. The control circuit of FIG. 3 also includes a resistor 67, which reduces the rolloff of the capacitor 68 so that the amplifier 60 operates over a broader bandwidth, and also includes a resistor 69 which establishes the gain of the amplifier 60.

The d.c. signal is applied to a light emitting element 87 in the Vatec cell 86. An increase in the d.c. signal increases the light emitted by the element 87, thus dropping the resistance value of the cell 86. The resistance value of the cell 86 is electrically coupled in parallel across the capacitor 56. The capacitor 56 and the resistor 62 are in the negative feed-back path from the transformer 46 to the sensing amplifier 60. The reactance of the capacitor 56 reaches a high value at the low end of the audio spectrum. This attenuation of the feed-back signal allows the output of the sensing amplifier 60 and hence the power amp 38 to increase as the frequency decreases to compensate for the decreasing efficiency of the loudspeaker 24. Thus, the capacitor 56 and the resistor 62 define a capacitive resistive network that introduces a 90° phase rotation in correcting for woofer loss of efficiency, for example in the frequency range of from 80 Hz down to 20 Hz.

In a negative feedback circuit, such as that shown in FIG. 3, if the phase of the feedback signal is rotated by 90°, the effect on the amplifier response is zero. The fact that the amplitude of the feedback signal is also attenuated allows the correction of the rather large change in woofer response, i.e. 24 db in two octaves, in this case 80 Hz to 20 Hz. This method of correcting for woofer response in this region may be used whether the negative feedback signal is generated in the manner depicted in FIG. 3 (from the loudspeaker in series with a transformer winding) or from a purely resistive network from the output of the power amplifier to ground, such as a beta network.

Stated another way, the capacitor 56 and the resistor 62 correct for loss of efficiency of a low frequency speaker not only because the Vatec cell 86 decreases the impedance of the capacitor 56, but also because the capacitor 56 has become reactive at 20 Hz and the shunting by 86 rotates the phase of the feedback signal back to zero shift. The combination of the phase rotation of the capacitor 56 and the resistor 62 of the feedback signal at 20 Hz causes the amplitude of the signal fed to the woofer to rise 24 db at 20 Hz and the action of the 86 eliminates this 24 db boost when it is not required at a higher frequency, such as 80 Hz.

However, as the resistance in the Vatec cell 86 decreases, at higher signal levels, the capacitor 56 is shunted and the strength of the feed-back signal to be maintained and the sound output of the speaker at low frequency is not enhanced as much.

The circuit of FIG. 3 also provides for the enhancement of high frequencies and mid-range frequencies. Note that a choke (inductor) 107 has been added in the positive current supply line to the speaker 10. Furthermore, a choke 97 has been added to feed a mid-range loudspeaker 77. A tweeter 78, for very high frequencies in the range of 10 kHz to 20 kHz is also provided. Thus, the circuit of the present invention provides frequency response enhancement for a plurality of loud speakers over the entire range of frequencies audible to the human ear.

The tweeter 78 and the mid-range speaker 77 are fed from a switch 91. The switch 91 is provided with a network, comprising a capacitor 103, a capacitor 104, an inductor 105, and a resistor 106. Also note that the low sides of all of the speakers are connected together and return to ground through the winding 48 on the transformer 46. The woofer 10 is connected into the circuit by a connector 79 and can be removed, if desired.

A switch 80 turns the woofer 10 on and off and also switches a capacitor 81 in series with the mid-range speaker 77 when the woofer 10 is on. The loudspeaker works very well without the very low frequency woofer in small rooms or when this speaker is used for the rear speakers in a surround sound configuration, hence the desirability of the use of the switch 80. The midrange loudspeaker 77 presents a very nearly resistive load to the crossover network which is the combination of the capacitor 81 and the choke 97. However, the loudspeaker does present some residual inductance which interferes with the action of the crossover network 81, 97. This can be easily compensated for by the addition of elements in the usual manner.

The switch 91 is preferably a three position switch. Set in a “high” position, the elements 104, 105, and 106 are shunted across and therefore shorted out of the circuit. In the mid or medium position, the elements 104, 105, and 106 are in parallel with one another and in series with the tweeter 78. In the low position, the elements 104 and 105 are in series with the tweeter, and the resistor 106 is open.

The circuit of FIG. 3 also provides for the enhancement of the high range of frequencies, roughly between 5 kHz and about 10 kHz. This circuit includes a switch 90 with three positions, high, medium, and low. Note that each position of the switch 90 is provided with a network comprising a pair of resistors 98 and 99 defining a divider network, a capacitor 100, and resistors 101 and 102. In the high position, the resistors 101 and 102 are open, and high frequency feedback is provided from the divider network of resistors 98 and 99. In the medium position, the resistor 101 is in series with the resistor 102, and the divider network is shunted. Finally, in the low position, the resistor 101 is shunted across the resistor 99.

For the control of mid-range frequencies, the control circuit includes a thre-position switch 89 to control the arrangement of resistor 109 and 110 and a capacitor 88. In a “high” position, the resistors 109 and 110 are coupled to ground through the transformer 46. In a “medium” position, the resistor 110 is grounded, which the resistor 109 is connected into a feedback line 111. Finally, in a “low” position, the resistors 109 and 110 are both coupled into the feedback line. An inductor 97 is coupled between the output of the power amp 38 and the positive input to the speaker 77.

Thus, the response of the speaker 77 is controlled on the high end (above 2 kHz) by the inductor 97. This element is chosen so that when feeding an 8 ohm speaker it rolls off at 6 db per octave above about 2 kHz. The problem is that the impedance of the speaker is not exactly 8 ohms resistive but has a residual of inductance of about 2 millihenry. This inductance alters the roll-off to be less than ideal. This error is corrected by an 8 ohm resistor, preferably comprising the parallel combination of resistor 109 and 110, and this 8 ohm resistor is switched in at high frequencies by a 10 microfarad capacitor 88. This 8 ohm resistor and capacitor are connected across speaker 77 and the current through them goes through the feedback winding 48. This corrects for the error in the cross-over very well.

Finally, control of low range frequencies, roughly about 20 Hz to about 1 kHz, is provided by a three-position switch 99 with a network of resistors 94, 96, and 117 and a capacitor 95. In the “high” position, the low frequencies are amplified by about 4 db, while the medium position, the frequency response it flat. In the high position, the frequencies in this range are damped by the same 4 db.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A loudness control circuit for a loudspeaker driven by a power amplifier, the loudness control circuit including a feedback loop carrying a feedback signal from the power amplifier, the feedback loop including a resistive capacitive network arranged to introduce a 90 degree phase shift in the feedback signal.

2. A control circuit for enhancing the frequency response of a loudspeaker, the loudspeaker comprising an acoustic wave producing member and a drive coil having a first and a second terminal, the drive coil adapted to produce movement of the member, and the loudspeaker adapted to be powered by a power amp having an output connected to the first terminal of the drive coil, and having an input adapted to receive an audio input signal, the output of the audio amplifier adapted to deliver a current signal correlative to the audio input signal, the control circuit comprising:
a feedback circuit operably connected to the audio amplifier, the feedback circuit comprising:
a full wave bridge rectifier to receive a signal level from the audio amplifier; a capacitor across the rectifier; and
a photoresistor across the capacitor to vary the resistance of the feedback circuit as a function of the signal level from the audio amplifier; and
a transformer having a primary winding and a secondary winding, the primary winding adapted to connect to the second terminal of said drive coil, and said secondary winding being connected to said feedback circuit, said feedback circuit delivering a feedback signal which alters said audio input signal in response to a voltage induced on said secondary winding b said primary winding.

3. The control circuit of claim 2, further comprising a frequency compensation circuit for a second, mid-range speaker, the frequency compensation circuit comprising:
a. an inductor at the output of the power amp;
b. a capacitor electrically coupled to the inductor;
c. a resistor electrically coupled to the capacitor; and
d. a multi-position switch between the resistor to ground; whereby alteration of the position of the multi-position switch varies the amplification of the power amp to the mid-range speaker.

4. The control circuit of claim 2, further comprising a frequency compensation circuit for a tweeter, the frequency compensation circuit comprising:
a. a multi-position switch coupled across the tweeter;
b. a resistor in series between the switch and the tweeter;
c. a capacitor in series between the switch and the tweeter; and
d. a parallel combination of a capacitor and an inductor in parallel with the switch, whereby selection of a position for the multi-position switch varies the frequency response of the tweeter.

5. The control circuit of claim 2, further comprising a lower frequency response curve selector circuit comprising:
a. a series combination of a first, second, and third resistors;
b. a capacitor in parallel with the second resistor; and
c. a switch coupled to the resistors and the capacitor to select predetermined combinations of the resistors and the capacitor.
